(19) United States
(12) Patent Application Publication
(10) Pub. No.: US 2026/0351252 A1
(43) Pub. Date: Nov. 5, 2026

(54) UTILIZING AI VOICE ASSISTANT'S VOICE NUANCE FOR CALLS

(71) Applicant: Samsung Electronics Co., Ltd., Suwon-si (KR)

(72) Inventors: Ji Yeon Han, Cliffside Park, NJ (US); Wenpin Li, South Orange, NJ (US); Myoung Woo Nam, Yongin-si (KR); Ha Jin Choi, Springfield, NJ (US); Yeun Wook Lim, Daegu (KR)

(21) Appl. No.: 19/195,426

(22) Filed: Apr. 30, 2025

(51) Int. Cl. G10L 15/183; G10L 13/033; G10L 15/18; G10L 15/22; G10L 15/30

(52) U.S. Cl. CPC G10L 15/183; G10L 13/033; G10L 15/1815; G10L 15/22; G10L 15/30

(57) ABSTRACT

An AI voice assistant monitors, using a voice AI model, a first audio segment received for a voice communication by a user to determine a purpose of the voice communication and a current context for the voice communication. The voice AI model intervenes in the voice communication in place of the user by outputting a second audio segment for the voice communication generated by the AI model with a first vocal nuance (for example, neutral). The voice AI model monitors the voice communication subsequent to the second audio segment. The voice AI model outputs a third audio segment for the voice communication generated by the AI model with a second vocal nuance (for example, assertive) different than the first vocal nuance. The second vocal nuance is selected based on a portion of the voice communication between the second audio segment and the third audio segment.

### TECHNICAL FIELD

This disclosure relates generally to AI voice assistants. More specifically, this disclosure relates to enabling the AI voice assistant to assist a caller with interaction with automated voice communication systems.

### BACKGROUND

Calling customer care is usually burdensome, requiring a lot of time and effort by the customer/user. Especially when the user needs to speak to a real human agent, there are typically multiple steps that the user needs to perform to reach the human agent. Usually, the user has to go through the interactive voice response (IVR) system to make selections within the call menu. Often the user has to listen through the entire menu for the desired selection, where the menu may have multiple depths or levels. After selection is made, the user still needs to be on hold for a long time-at least a few minutes and sometimes up to an hour. During the call wait, the user needs to stay attentive to the call so that, when the agent picks up, the opportunity to speak to the agent is not missed.

### SUMMARY

This disclosure relates to AI voice assistants.

In a first embodiment, a method of providing nuance for an artificial intelligence (AI) voice assistant on an electronic device includes monitoring, using a voice AI model, a first audio segment received for a voice communication by a user to determine a purpose of the voice communication and a current context for the voice communication. The method also includes intervening, using the voice AI model, in the voice communication in place of the user by outputting a second audio segment for the voice communication generated by the AI model with a first vocal nuance. The method further includes monitoring, using the voice AI model, the voice communication subsequent to the second audio segment. The method still further includes outputting, using the voice AI model, a third audio segment for the voice communication generated by the AI model with a second vocal nuance different than the first vocal nuance. The second vocal nuance selected based on information relating to a portion of the voice communication between the second audio segment and the third audio segment.

In a second embodiment, an electronic device that provides nuance for an artificial intelligence (AI) voice assistant on the electronic device includes at least one processing device on which a voice AI model operates. The at least one processing device is configured to monitor, using the voice AI model, a first audio segment received for a voice communication by a user to determine a purpose of the voice communication and a current context for the voice communication. The at least one processing device is also configured to intervene, using the voice AI model, in the voice communication in place of the user by outputting a second audio segment for the voice communication generated by the AI model with a first vocal nuance. The at least one processing device is further configured to monitor, using the voice AI model, the voice communication subsequent to the second audio segment. The at least one processing device is still further configured to output, using the voice AI model, a third audio segment for the voice communication generated by the AI model with a second vocal nuance different than the first vocal nuance, the second vocal nuance selected based on information relating to a portion of the voice communication between the second audio segment and the third audio segment.

In a third embodiment, a non-transitory machine readable medium for providing nuance for an artificial intelligence (AI) voice assistant on an electronic device includes instructions that, when executed, cause at least one processing device of an electronic device to monitor, using the voice AI model, a first audio segment received for a voice communication by a user to determine a purpose of the voice communication and a current context for the voice communication. The instructions, when executed, also cause at least one processing device to intervene, using the voice AI model, in the voice communication in place of the user by outputting a second audio segment for the voice communication generated by the AI model with a first vocal nuance. The instructions, when executed, further cause at least one processing device to monitor, using the voice AI model, the voice communication subsequent to the second audio segment. The instructions, when executed, still further cause at least one processing device to output, using the voice AI model, a third audio segment for the voice communication generated by the AI model with a second vocal nuance different than the first vocal nuance. The second vocal nuance is selected based on information relating to a portion of the voice communication between the second audio segment and the third audio segment.

Any single one or any combination of the following features may be used with any of the first, second, or third embodiments. The second vocal nuance may be selected based on determination, from the information relating to the portion of the voice communication between the second audio segment and the third audio segment, of factors including one or more of: a duration of time between one of the first audio segment and the third audio segment or the second audio segment and the third audio segment; keywords within the voice communication; context indicators relating to the voice communication, including indications of progress toward resolution of a subject of the voice communication; a number of questions occurring during the voice communication; or a number of changes in a respondent for the voice communication. The first vocal nuance and the second vocal nuance may each be selected from: neutral, assertive, or satisfied. The second audio segment may mimic a voice of the user with the first vocal nuance, and the third audio segment may mimic the voice of the user with the second vocal nuance. The method may also include displaying a graphical user interface (UI) for controlling use of the voice AI model in the voice communication. The graphical UI may include a first user control for initiating intervention using the voice AI model in the voice communication. The graphical UI may include a second user control for initiating resumption by the user of user participation in the voice communication. Upon resumption by the user of user participation in the voice communication, the graphical UI may include a display of a summary of the voice communication between the second audio segment and the resumption by the user of user participation in the voice communication. The method may include alerting the user that resumption by the user of user participation in the voice communication is needed in response to one of: a human respondent initiating participation in the voice communication, or a question in the voice communication requiring user participation in the voice communication. Alerting the user that resumption by the user of user participation in the voice communication is needed may include providing a notification to one or more connected devices that are connected to the electronic device, wherein the one or more connected devices comprise at least one of a wearable device and an Internet of Things (IoT) device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration 100 that may be employed for utilizing an AI voice assistant with voice nuance for calls in accordance with this disclosure;

FIG. 2 illustrates an example process of providing nuance for an artificial intelligence (AI) voice assistant on an electronic device in accordance with this disclosure;

FIG. 3 is a diagram illustrating a system for utilizing an AI voice assistant with voice nuance for calls in accordance with this disclosure;

FIG. 4 illustrates an exemplary communications flow for voice communications utilizing an AI voice assistant with voice nuance in accordance with this disclosure;

FIGS. 5A and 5B illustrate a flowchart for an exemplary process of voice communications utilizing an AI voice assistant with voice nuance in accordance with this disclosure;

FIG. 6 depicts examples of voice nuance that an AI voice assistant may present to a human agent during voice communications sessions utilizing an AI voice assistant with voice nuance in accordance with this disclosure;

FIGS. 7A through 7H depict examples of user interface displays for an AI voice assistant may present to a caller during voice communications sessions utilizing an AI voice assistant with voice nuance in accordance with this disclosure; and

FIG. 8 depicts an example environment 800 for call handover during voice communications sessions utilizing an AI voice assistant with voice nuance in accordance with this disclosure.

### DETAILED DESCRIPTION

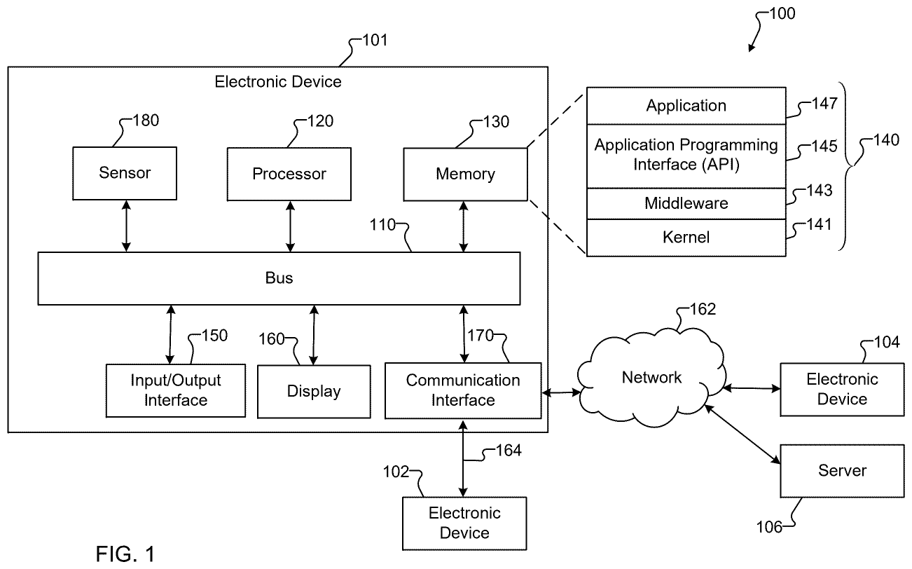

FIGS. 1 through 8, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

The present disclosure helps users reduce the effort, time, and presence needed to handle a care call. Utilizing the power of AI, the user's voice is mimicked in different nuances to talk on behalf of the user. A user interface is designed to help visualize the process of AI handling the call, and even give a summary once AI intervention in the conversation with the agent is complete. Lastly, alert logic provides notifications to any wearable device that the user is wearing when the call reaches a real agent, to hand off the call to the user.

The present disclosure describes when and how to utilize AI generated voice nuance during a customer care call. The three typical types of voice nuance may be expected during a customer care call: neutral, assertive/urgent, and satisfied. Determining factors of when to use what nuance may include:
Time passed: As time goes by without any progress in the resolution, the vocal nuance will become more assertive.
Context/keywords: The AI detects the general context of the conversation and keywords such as “accidents” or “emergency” to determine the initial nuance.
Number of questions asked/call transfers: More repeated questions and call transfers leads to more assertive nuance.

In the present disclosure, a graphical user interface provides a way for users to seamlessly take over the call from the voice AI or have voice AI take over the call. When the AI is still talking, the user should not interrupt the call. The AI can provide a short script to the users to seamlessly take over the call.

In the present disclosure, when the call reaches a real human agent, the AI speaks on behalf of the caller to resolve the issue. If the user is away from or not attentive to the device on which the AI operates, the AI alerts the caller to take over the call. If the user is connected to a watch or ring, the AI can detect if the caller is coming back to the phone using (for example) Bluetooth™ technology and prepare for a call handover.

FIG. 1 illustrates an example network configuration 100 that may be employed for utilizing an AI voice assistant with voice nuance for calls in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to utilizing an AI voice assistant with voice nuance for calls.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to utilizing an AI voice assistant with voice nuance for calls. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232(RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network. The electronic device 101 can also be an augmented reality wearable device, such as eyeglasses, which include one or more imaging sensors, or a VR or XR headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the electronic device 101 and/or the server 106 may perform various operations related to utilizing an AI voice assistant with voice nuance for calls. For example, an AI voice assistant on the electronic device 101 may be employed to interact with the user and to employ voice nuance while handling calls on behalf of the user.

Although FIG. 1 illustrates one example of a network configuration 100 including an electronic device 101 employed providing personalized summarization content based on content consumption and user status, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

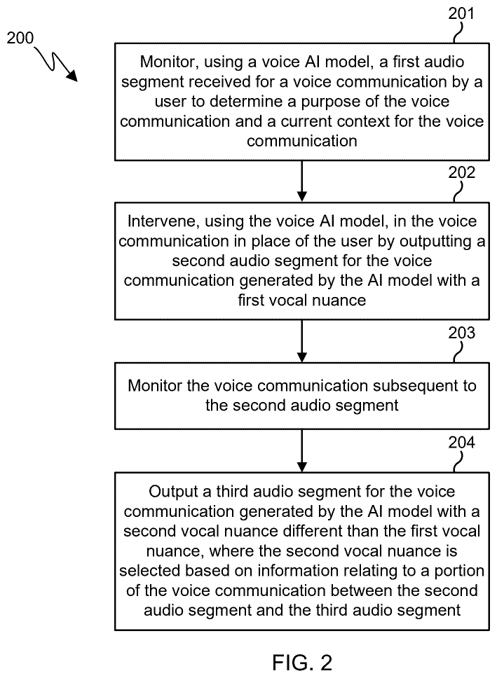

FIG. 2 illustrates an example process 200 of providing nuance for an artificial intelligence (AI) voice assistant on an electronic device in accordance with this disclosure. For ease of explanation, the process 200 of FIG. 2 is described as being performed using the electronic device 101 in the network configuration 100 of FIG. 1. However, the process 200 may be performed using any other suitable device(s) and in any other suitable system(s).

As shown in FIG. 2, the process 200 begins with monitoring, using a voice AI model, a first audio segment received for a voice communication by a user to determine a purpose of the voice communication and a current context for the voice communication (step 201). The determination of purpose for the voice communication may involve prompting the caller for input as to the purpose of the call, and/or identifying keywords in the first audio segment.

The voice AI model intervenes in the voice communication in place of the user by outputting a second audio segment for the voice communication generated by the AI model with a first vocal nuance (step 202). The first vocal nuance may be determined based on several factors. For example, the first vocal nuance may be selected based on the identified keywords, the purpose of the call, or both. The first vocal nuance may also be customer call line type, which should be identified to pre-determine the type of the call. For example, an emergency call (e.g., to 911, in the United States) or a call to a stored roadside assistance number should be detected and treated differently from a call to a regular 800- business number. The second audio segment may mimic the caller's voice, but with the first vocal nuance applied. Alternatively, the second audio segment may comprise touch tones for selecting options in response to an automated phone system at the receiver of the voice communication. The second audio segment may navigate menu options on behalf of the caller until the voice communication is placed on a hold status.

The voice AI model monitors the voice communication subsequent to the second audio segment (step 203). If a human agent at the receiver of the voice communication begins participating in the voice communication, the voice AI model may alert the caller. Even if a human agent at the receiver of the voice communication begins participating in the voice communication, the voice AI model may participate in the voice communication by outputting audio in response to questions or statements by the human agent.

The voice AI model outputs a third audio segment for the voice communication generated by the AI model with a second vocal nuance different than the first vocal nuance (step 204). Output of the third audio segment with the second vocal nuance may be triggered a time elapsed subsequent to the human agent beginning participation in the voice communication. Alternatively, output of the third audio segment with the second vocal nuance may be triggered by context indicators from the voice communication, such as indications of progress toward resolution of the issue that is the subject of the voice communication. The second vocal nuance selected based on information relating to a portion of the voice communication between the second audio segment and the third audio segment. That information can include a duration of time between one of the first audio segment and the third audio segment or a duration of time between the second audio segment and the third audio segment. The information may include a number of questions occurring during the voice communication. The information may include a number of changes in a respondent for the voice communication, as when the voice communication is redirected to different respondents.

Although FIG. 2 illustrates one example of a process 200 of utilizing an AI voice assistant with voice nuance for calls, various changes may be made to FIG. 2. For example, while shown as a series of steps, various steps in FIG. 2 could overlap, occur in parallel, occur in a different order, or occur any number of times (including zero times).

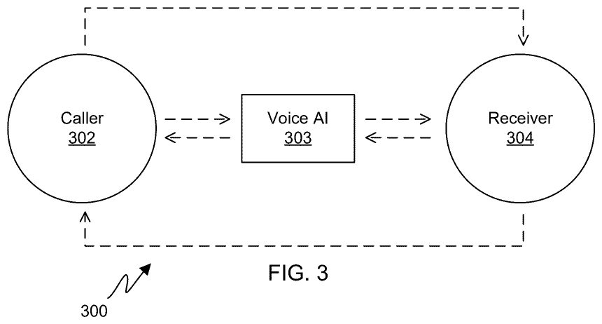

FIG. 3 is a diagram illustrating a system 300 for utilizing an AI voice assistant with voice nuance for calls in accordance with this disclosure. For ease of explanation, the system 300 of FIG. 3 is described as being implemented within the electronic device 101 and/or the server 106 in the network configuration 100 of FIG. 1, operating interactively. However, the system 300 may be implemented using any other suitable device(s) and in any other suitable system(s).

In the system 300 of FIG. 3, a caller 302 (e.g., a customer) initiates a voice communication session such as a customer care call. The voice communications are routed through (and optionally also around) an AI voice assistant 303 on an electronic device 101. The AI voice assistant 303 either obtains sufficient audio samples to be trained to mimic the user's voice or has already been trained to mimic the user's voice. In either case, the AI voice assistant 303 is or has been trained to mimic the user's voice with certain predefined types of voice nuance, described in further detail below. The AI voice assistant 303 also obtains the purpose of the customer care call, for example, based on the customer call line type as discussed above, or either by monitoring the user's speech during initiation of the customer care call, by prompting the user for input regarding the purpose of the customer care call, or both.

The receiver 304 is a customer care call center, and includes an automated phone system of the type that, for example, uses pre-recorded messages and call routing to manage incoming calls (e.g., by answering calls, presenting options to callers, and then routing the calls to the appropriate department(s) or individual(s)) without the need for a live human agent during at least initial portions of the call. The receiver 304 also includes one or more live human agent(s). The caller 302 and/or AI voice assistant 303 can initiate the customer care call and, at some point, the AI voice assistant 303 may intervene and begin handling the call, freeing the caller 302 to turn their attention to other matters and optionally leave the vicinity of the device. The AI voice assistant 303 may navigate the automated phone system and, once a human agent has been reached, initiate a communication with the human agent from customer care (at receiver 304). When the caller 302 is ready, the human agent at the receiver 304 and the caller 302 will communicate directly. The call can also be subsequently passed back over to AI voice assistant 303 in situations where the call is again put on hold.

Although FIG. 3 illustrates one example of a system 300 for utilizing an AI voice assistant with voice nuance for calls, various changes may be made to FIG. 3. For example, while depicted as a single model, the AI voice assistant and an AI voice model for navigating an automated phone system and handling interaction with a human customer care agent may be separate models, invoked on different occasions for different tasks.

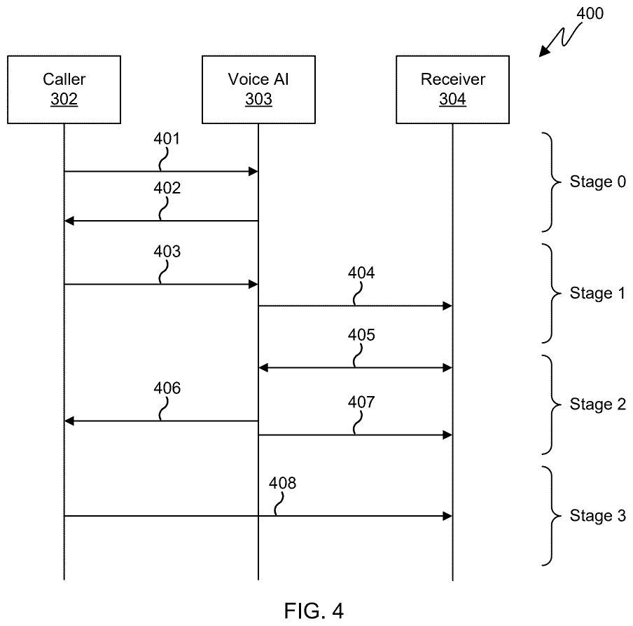

FIG. 4 illustrates an exemplary communications flow 400 for voice communications utilizing an AI voice assistant with voice nuance in accordance with this disclosure. For ease of explanation, the communications flow 400 of FIG. 4 is described as being performed using the electronic device 101 in the network configuration 100 of FIG. 1 to receive input from the caller 302 and utilizing the AI voice assistant 303 of FIG. 3. However, the communications flow 400 may be performed using any other suitable device(s) and in any other suitable system(s).

During stage 0 of the communications flow 400, the AI voice assistant 303 learns the initial nuance for a voice communications session to be initiated. The caller 302 explains the purpose of the call to the AI voice assistant 303 (communication(s) 401). The AI voice assistant 303 may seek explicit confirmation (communication(s) 402) from the caller of the caller's initial nuance, or alternatively may infer an appropriate initial nuance from the explanation of the purpose. The AI voice assistant 303 may also capture the user's voice to determine qualities (tone, pitch, fundamental frequency, etc.) for purposes of mimicking the user (with nuance) if collection of the user's voice has not been previously performed or if additional samples of the user's voice are needed. During stage 1 of the communications flow 400, the task of the voice communications session is initiated. The caller 302 initiates a customer care call and instructs the AI voice assistant 303 to handle the call on behalf of the caller 302 (communication(s) 403). The AI voice assistant 303 then proceeds to navigate the menu selections of an automated phone system (communication(s) 404) and monitor the communications flow 400 during any call waiting period.

During stage 2 of the communications flow 400, the AI voice assistant 303 performs the task of the voice communications session. The AI voice assistant 303 conducts the voice communications session conversation with the receiver 304 (communication(s) 405). When a human agent takes over the voice communications session from the automated phone system on behalf of the receiver 304, the AI voice assistant 303 sends an alert to the caller 302 (communication(s) 406). The AI voice assistant 303 may continue to interact with the receiver 304 while awaiting resumption of participation by the caller 302 (communication(s) 407). During stage 3 of the communications flow 400, the AI voice assistant 303 hands over the call. In response to a signal by the caller 302 (communication(s) 408), the AI voice assistant 303 can hand over the communications session, and the caller 302 can assume an active participation in the voice communications session.

Although FIG. 4 illustrates one example of a communications flow 400 for voice communications utilizing an AI voice assistant with voice nuance, various changes may be made to FIG. 4. For example, while shown as a series of communications, various communications in FIG. 4 could overlap, occur in a different order, or occur any number of times (including zero times), and communications depicted as a single communication could actually comprise a plurality of communications that, in some instances, may also include communications in the opposite direction from that shown.

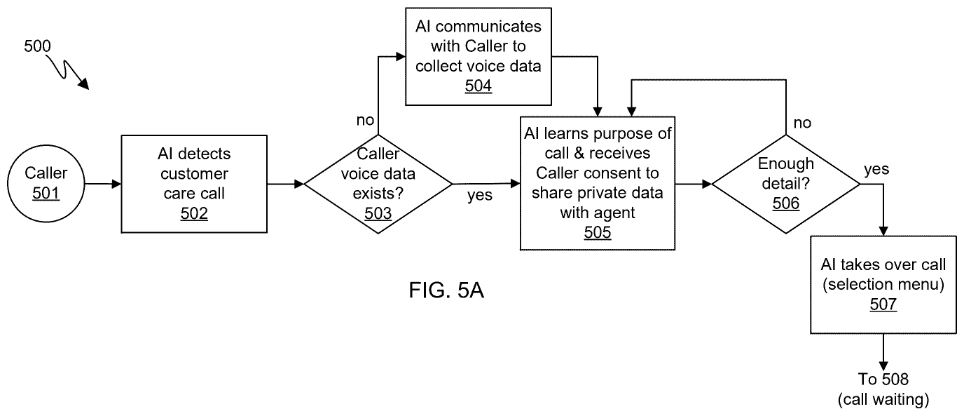

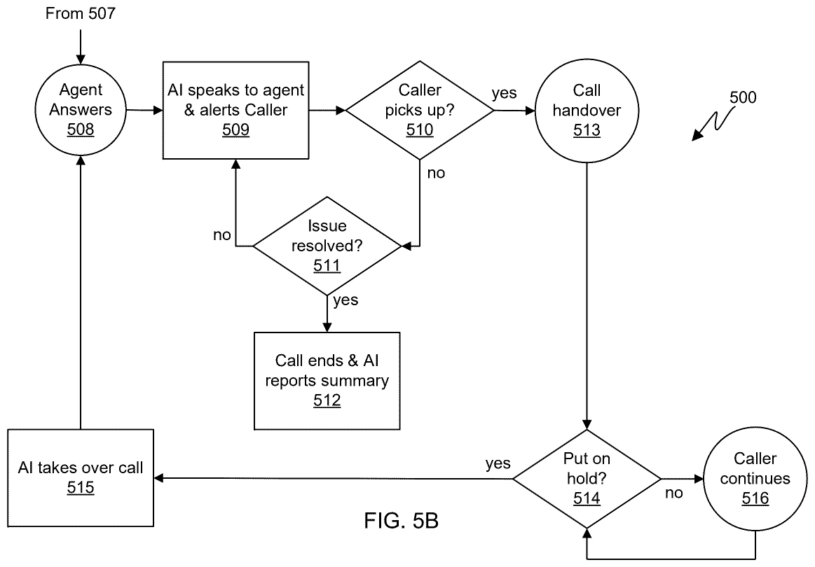

FIGS. 5A and 5B illustrate a flowchart for an exemplary process 500 of voice communications utilizing an AI voice assistant with voice nuance in accordance with this disclosure. For ease of explanation, the process 500 of FIGS. 5A and 5B is described as being performed using the electronic device 101 in the network configuration 100 of FIG. 1 to receive input from the caller 302 and utilizing the AI voice assistant 303 of FIG. 3. However, the process 500 may be performed using any other suitable device(s) and in any other suitable system(s).

The process 500 of FIGS. 5A and 5B begins with a caller initiating a voice communication (step 501) for a customer care call (for example). The AI voice assistant detects the voice communication (step 502) and determines if sufficient caller voice data exists to allow mimicking of the caller's voice with nuance (step 503). If not, the AI voice assistant communicates with the call to collect sufficient voice data (step 504). Once sufficient voice data exists (or if sufficient voice data already existed at step 503), the AI voice assistant learns the purpose of the call and obtains the caller's express consent to share private data with the receiver of the customer care call (step 505), as needed to complete the purpose of the call. The AI voice assistant determines whether enough detail about the purpose of the call has been obtained (step 506). If not, the process returns to step 505 to prompt the caller for additional details. Once enough detail has been obtained, the AI voice assistant takes over the call (step 507) and navigates the selection menu of the automated voice system for customer care until the call is placed on call waiting status.

The AI voice assistant monitors the call for the duration of the call waiting period, until a human agent at the receiver answers (step 508). Once a human agent answers, the AI voice assistant speaks to the agent and alerts the caller (step 509). The AI voice assistant monitors the caller's participation until the caller picks up (step 510). While waiting for the caller to pick up, the AI voice assistant continues to speak to the customer care agent until the AI voice assistant determines that issue which prompted the call is resolved (step 511). If the issue is resolved without the caller picking up, the AI voice assistant ends the call and reports a summary of the results to the caller (step 512) in, for example, a text-based summarization. The summary may also be made available to the user if the user is requested to take a satisfaction survey after the end of the call.

When the issue that prompted the call cannot be resolved without participation by the caller, or whenever the caller picks up (step 510), the call is handed over to the caller (step 513). If the call is put back on hold (step 514), the AI voice assistant once again takes over the call until a human agent resumes handling of the call for the receiver. As long as the call is not put on hold, the caller continues handling the call (step 516).

Although FIGS. 5A and 5B illustrates one example of a process 500 of voice communications utilizing an AI voice assistant with voice nuance, various changes may be made to FIGS. 5A and 5B. For example, while shown as a series of steps, various steps in FIGS. 5A and 5B could overlap, occur in parallel, occur in a different order, or occur any number of times (including zero times).

Using user voice data and AI, the voice of the caller can be mimicked. However, the application of nuance to the caller's voice is another level of system defined in the present disclosure. Application of voice nuance provides more real interaction with the human agent at the receiver. In the present disclosure, the appropriate voice nuance is determined based on three different factors:
1. Time spent: In a typical customer care call, the nuance of the voice will become more assertive and angry as more time passes. For example, the time interval of increasing assertive emotion may be in 10 minute intervals—that is, during the first 10 minutes of the call (including time on call waiting), the voice nuance may be neutral.
2. Context/Keywords: In certain situations where the issue is urgent, the caller's urgency is detected and delivered. For example, if the call relates to urgent roadside assistance, an urgent voice nuance may be presented from the beginning of the call.
3. Number of questions asked/call transfers: the number of questions asked and/or the number of call transfers are another factor that can bring more irritation to users. To best represent the user, a more assertive tone may be presented on that basis.
   In the present disclosure, three types of voice nuance are considered: neutral, assertive/urgent, and satisfied. However, other types of voice nuance could be applied, such as sarcastic or outraged. Considering that the example voice communication session is a customer care call with a purpose to resolve certain issues, the above-identified factors (and others) may be employed to determine when to apply which voice nuance.

The AI voice assistant can collect caller voice data during a regular call or customer care call to mimic the caller's voice. To collect voice nuance data, the AI voice assistant will have a brief conversation with the caller, prompting the caller to emote each individual voice nuance (for example, while obtaining information about the call purpose). The nuance of the audio generated by the AI voice assistant will be created based on the call duration and context. Utilizing the caller's voice data that was previously collected, the AI voice assistant will initiate a conversation with a human agent using a voice nuance determined based on call duration and context. Meanwhile, the AI voice assistant also pushes alerts to the caller take over the call.

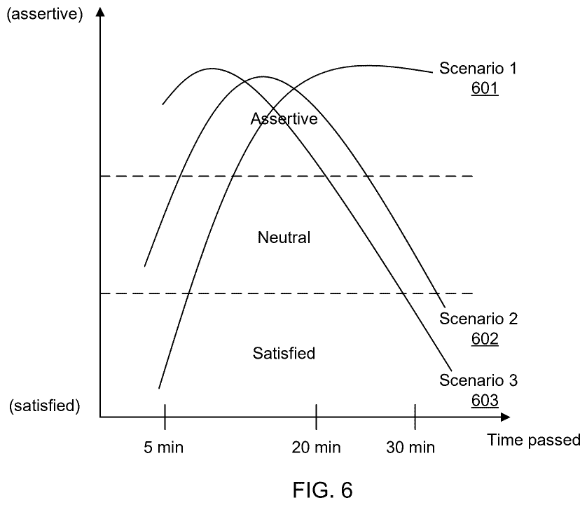

FIG. 6 depicts examples of voice nuance that an AI voice assistant may present to a human agent during voice communications sessions utilizing an AI voice assistant with voice nuance in accordance with this disclosure. For ease of explanation, the examples 601, 602, and 603 of FIG. 6 are described as occurring during performance of the process 500 of FIGS. 5A and 5B. However, the exemplary voice nuance patterns (and others) may occur during the performance of any other suitable process(es), in any suitable device(s) and in any other suitable system(s).

FIG. 6 depicts examples of nuance that the AI voice assistant may present to the human agent. The examples 601, 602, and 603 relate to use of three types of voice nuance as described above: neutral, assertive/urgent, and satisfied. However, the examples may be readily extended to more or fewer types of voice nuance. In addition, users may selectively configure the types of voice nuance, such as by limiting the voice nuances applied to only neutral and satisfied. In some instances, the voice nuances may be automatically limited to only neutral and satisfied. For example, if the questions need to be repeatedly asked by the automated phone system for purposes of verification, or if a question requests for the caller's consent to or understanding of a required disclaimer, the voice nuance need not be outraged or assertive. The voice nuances are applied in the examples 601, 602, and 603 based on call duration and context as described above. However, users may selectively configure parameters controlling selection of voice nuance to be applied, such as longer or shorter call duration.

In general, the initial voice nuance and changes in voice nuance are determined based on factors such as time passed, context, key words, call transfers, and number of questions asked. In example Scenario 1 601, the voice nuance is satisfied in the beginning but, as time goes by, becomes assertive as issue is not resolved. For as long as issue is not being resolved, the voice nuance may continue in an assertive tone. In example Scenario 2 602, the initial voice nuance is neutral in the beginning, but as time goes by becomes assertive. As the issue is resolved, the voice nuance shifts and ends with the satisfied tone when the issue is resolved. In example Scenario 3 603, the situation is urgent (e.g., roadside assistance is needed) such that the initial voice nuance is reflects urgency at first, but progresses and ends with the satisfied tone when the issue is resolved.

Although FIG. 6 depicts three examples of voice nuance that an AI voice assistant may present to a human agent during voice communications sessions utilizing an AI voice assistant with voice nuance, various other examples can be easily envisioned based on those depicted in FIG. 6. For example, while shown as a smooth progression between an initial voice nuance and an ending voice nuance, the voice nuance may cycle between the types depicted based on progress toward resolving the issue.

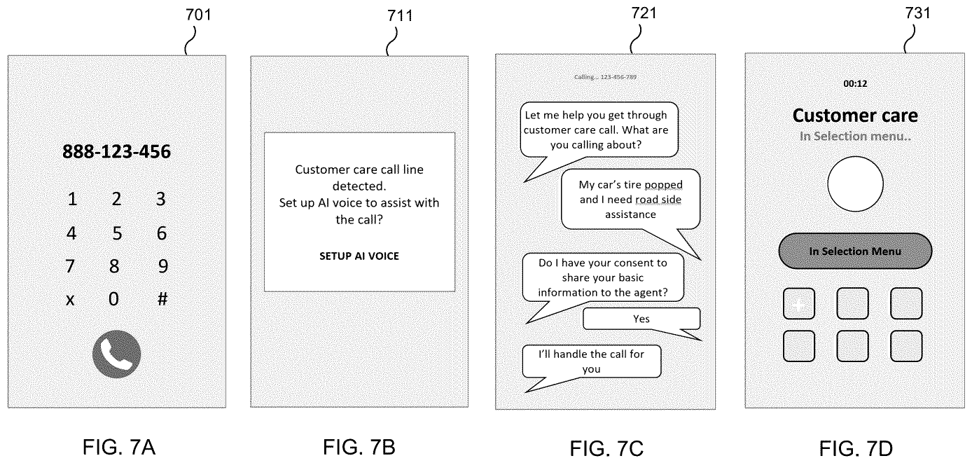

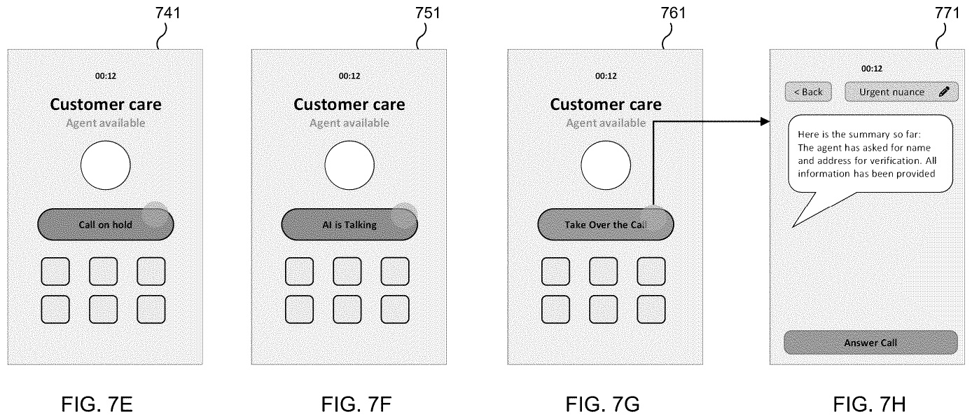

FIGS. 7A through 7H depict examples of user interface displays for an AI voice assistant may present to a caller during voice communications sessions utilizing an AI voice assistant with voice nuance in accordance with this disclosure. For ease of explanation, the examples 701, 711, 721, 731, 741, 751, 761, and 771 of FIGS. 7A through 7H are described as being displayed during performance of the process 500 of FIGS. 5A and 5B. However, the exemplary user interfaces (and others) may be displayed during the performance of any other suitable process(es), in any suitable device(s) and in any other suitable system(s).

The examples 701, 711, 721, 731, 741, 751, 761, and 771 depict graphical user interfaces (UIs) presented by the AI voice assistant throughout the customer care call, to assist the user in managing the customer care call. The examples of FIGS. 7A through 7H assume that the AI voice assistant is integrated with a voice communications app (e.g., a phone app), at least to the extent necessary to detect dialed numbers. In the example 701 of FIG. 7A, the caller initiates a customer care call. Initiation of a customer care call may be based on the number dialed (e.g., an 800 or 888 number, or a number listed on the Internet and/or stored in the electronic device 101 and identified as customer care or urgent services).

Voice detection and analysis on the caller's voice may be performed during regular day-to-day calls, with user consent. Alternatively, if not previously collected, the caller's voice data may be collected during subsequent steps. In addition, the caller may be automatically prompted to set up the AI voice assistant, if not previously performed. For instance, the example 711 of FIG. 7B may be displayed, inviting the user to set up the AI voice assistant to help with the call. If the AI voice assistant was set up before initiation of the call, the caller may assign tasks to AI by voice or text before the call connection to customer care is complete. The conversation between the caller and the AI voice assistant may be displayed in the graphical UI.

The example 721 of FIG. 7C is a conversation view of the interaction between the caller and the AI voice assistant prior to the call connection to customer care being completed. During this interaction, the AI voice assistant learns the purpose of the call (and collects voice data, if not previously collected), and obtains consent from the caller to share at least basic user information with the customer care system. A live transcription of the conversation between the caller and the AI voice assistant is visible through the graphical user interface. Keyboard input is also available, so that the caller can elect keyboard input for any portion of the interaction with the AI voice assistant. The caller may communicate with the AI voice assistant to ask questions, or to demand or request that the AI voice assistant deliver a specific message to the receiver.

The example 731 of FIG. 7D is a calling view displayed upon completion of the call connection to customer care, and the AI voice assistant navigates the interactive voice response (IVR) automated phone system used for customer care. For example, the AI voice assistant may display the status “In Selection Menu” to inform that user that the IVR selection menu is being navigated. Among the options that may be included in the display for example 731 are a control allowing the user to edit the voice nuance parameters (for example, specifying a particular type of initial voice nuance). The IVR selection menu options may also be displayed, and may be viewed by the caller in the conversation view.

The example 741 of FIG. 7F reflects the status of the call being on hold, while the example 751 of FIG. 7F reflects that the AI voice assistant is talking to the customer care system. In the beginning of a conversation with a human customer care agent, the AI voice assistant may provide basic user information such as name, address, and call back phone number (with user setup or other explicit consent). The AI voice assistant preferably mimics the caller's voice throughout any conversation with a human agent, called so that the receiver party does not disconnect the call in response to an apparent automated voice or based on a change in the voice. If legally required, the receiver may be informed that an AI voice assistant is speaking on behalf of the caller. The “Call on hold” status in example 741 and the “AI is talking” status in example 751 may be user touch controls, enabling the caller to hear the (held) call or the conversation between the AI voice assistant and the receiver (or view a live transcript, in the conversation view).

The example 771 of FIG. 7G is displayed when the AI voice assistant is prompting the caller to take over the call (i.e., hand over the call to the caller). The “Take over the call” status may highlight or blink to present urgency, if the caller must take over the call to continue (e.g., the received needs a real human to identify or authenticate themselves). The “Take over the call” status in example 771 may be user a user touch control enabling the caller to initiate handover. As shown in the example 781 of FIG. 7H, activation of that user touch control may bring up a summarization of the call progress and current status, together with a user touch control to “Answer Call.”

Handover timing may be determined by the AI voice assistant based on the situation. The AI voice assistant displays an appropriate graphical user interface (GUI) to reflect 1) the status of “call handover task,” and/or 2) the right time to switch and handover. Accordingly, other examples of the call status include: “Agent is talking”; “Call is being transferred”; or “Take over the call in x minutes.” The call status could also reflect, in real time in an animation, one state after another. However, if the caller wishes, the caller can take over the call any time, even while AI is communicating to the receiver. Any or all of the examples 731, 741, 751, 761, 771, or 781 support real time interaction, under which the caller can jump in whenever the caller wants, and may show different statuses of the button(s) (such as a list of button status and corresponding action that the caller may take, or the ability to hear the AI voice assistant and human agent talking). As noted above, after completion of the call, a summary of the entirety of the call (including the portion handled by the call as well as the portion handled by the AI voice assistant) may be made available to the user for the user's later reference, such as if the user is requested to take a satisfaction survey after the end of the call.

Although FIGS. 7A through 7H depict eight examples of user interface displays that an AI voice assistant may display during voice communications sessions utilizing an AI voice assistant with voice nuance, various other examples can be easily envisioned based on those depicted in FIGS. 7A through 7H. For example, intervening user interfaces may be displayed at any point.

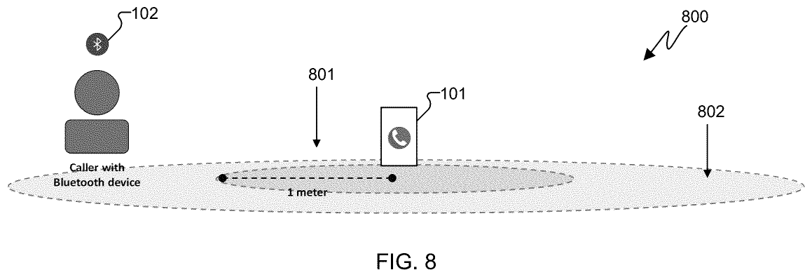

FIG. 8 depicts an example environment 800 for call handover during voice communications sessions utilizing an AI voice assistant with voice nuance in accordance with this disclosure. For ease of explanation, the environment 800 is explained using the electronic device 101 and the electronic device 102 of FIG. 1. In the example depicted, the electronic device 102 is Bluetooth™ enabled and connected to the electronic device 101. For example, the electronic device 101 may be a smart phone on which the AI voice assistant operates, and the electronic device 102 may be a wearable device such as a smart watch or air buds. However, the exemplary AI voice assistant with voice nuance may be employed with any other suitable device(s) and in any other suitable system(s).

As described above, when the call reaches a real human agent, the AI voice assistant speaks on behalf of the caller to resolve the issue and if the user is away from or not attentive to the electronic device 101, will alert the caller to take over the call. If the user is connected to a smart watch or smart ring (i.e., electronic device 102), the AI voice assistant can detect when the caller is back close to the electronic device 101 using Bluetooth™ technology, and prepare for a call handover (e.g., the AI voice assistant could finish the sentence in progress, and ask the receiver to hold on briefly as described below). Bluetooth™ 6.0 technology can detect the distance between of different devices with centimeter level accuracy, which the present disclosure leverages for a seamless call handover. When the caller is away from the electronic device 101, the AI voice assistant will perform one or more of the following based on whether the caller (and the electronic device 102 being worn by the user) is within a region 801 that is a predetermined distance (1 meter, in the example 800) around the electronic device 101:
alert the caller's wearable device(s); or
alerts the caller through IoT devices with which the caller is interacting (i.e., a speaker, television, refrigerator, etc.), particularly if the caller is in a region 802 outside the predetermined distance.
   Depending on the urgency and need of the caller (human) to respond, the level of notification can differ. For example, if the customer care receiver requires an actual human to verify identity, the alert will intensify to prompt the caller to pick up the phone.

As the caller with the wearable electronic device 102 approaches back to the area of the electronic device 101, the AI voice assistant will behave as follows:
Stop speaking and finish the sentence with the human customer care agent.
Display a transcript or summary of the discussion with the human agent on the electronic device 101.
Ask the human customer care agent to hold a bit, allowing time for the caller to read through the existing conversation and resume the call.
   Optionally, the AI voice assistant may continue the conversation with the human customer care agent in response to a simple question (an inform the caller through the GUI).

Although FIG. 8 depicts one example of an environment 800 for call handover during voice communications sessions utilizing an AI voice assistant with voice nuance, various changes may be made to FIG. 8. For example, while shown as defining two regions for distance of the caller from the electronic device 101 in which the AI voice agent operates, more regions could be defined based on the specific location of the caller (e.g., within a toilet area).

Several use cases for the AI voice assistant with voice nuance may be readily envisioned. In one use case, a caller with a deflated car tire on a highway at night needs immediate roadside assistance while, at the same time, also needs put up an alert sign to avoid (further) accidents. The caller can initiate a call to roadside assistance, explaining the situation to the AI voice assistant that will recognize the emergency and contact roadside assistance on behalf of the caller. The AI voice assistant will go through the selection menu before reaching the real human agent. Once the real agent is reached, the AI voice assistant will alert the users using multiple methods. Once the caller is ready, the caller picks up the call to talk to the human agent themselves. In an alternative use case the caller places a call to get a part replaced for a specific product and has their account blocked after multiple incorrect password attempts. The caller initiates a call to customer care service and explains both problems to the AI voice assistant. The AI voice assistant will contact the appropriate customer care department through the selection menu and monitors the call while on call waiting. When a real human agent picks up, the AI voice assistant alerts the caller and hands over the call while communicating with the real human agent to initiate the conversation. Once the initial problem is fixed, if the human agent transfers the call to another department and caller is again put on hold, repeating the call wait and handover process.

Any feature described above in connection with FIGS. 2 through 8 may be used together, in any combination with one or more other feature(s) described above. It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method of providing nuance for an artificial intelligence (AI) voice assistant on an electronic device, the method comprising:
monitoring, using a voice AI model, a first audio segment received for a voice communication by a user to determine a purpose of the voice communication and a current context for the voice communication;
intervening, using the voice AI model, in the voice communication in place of the user by outputting a second audio segment for the voice communication generated by the AI model with a first vocal nuance;
monitoring, using the voice AI model, the voice communication subsequent to the second audio segment; and
outputting, using the voice AI model, a third audio segment for the voice communication generated by the AI model with a second vocal nuance different than the first vocal nuance, the second vocal nuance selected based on information relating to a portion of the voice communication between the second audio segment and the third audio segment.

2. The method of claim 1, wherein the second vocal nuance is selected based on determination, from the information relating to the portion of the voice communication between the second audio segment and the third audio segment, of factors including one or more of:
a duration of time between one of the first audio segment and the third audio segment or the second audio segment and the third audio segment;
keywords within the voice communication;
context indicators relating to the voice communication, including indications of progress toward resolution of a subject of the voice communication;
a number of questions occurring during the voice communication; or
a number of changes in a respondent for the voice communication.

3. The method of claim 1, wherein the first vocal nuance and the second vocal nuance are each selected from:
neutral,
assertive, or
satisfied.

4. The method of claim 1, wherein the second audio segment mimics a voice of the user with the first vocal nuance, and wherein the third audio segment mimics the voice of the user with the second vocal nuance.

5. The method of claim 1, further comprising:
displaying a graphical user interface (UI) for controlling use of the voice AI model in the voice communication, including
a first user control for initiating intervention using the voice AI model in the voice communication, and
a second user control for initiating resumption by the user of user participation in the voice communication; and
upon resumption by the user of user participation in the voice communication, displaying a summary of the voice communication between the second audio segment and the resumption by the user of user participation in the voice communication.

6. The method of claim 1, further comprising:
alerting the user that resumption by the user of user participation in the voice communication is needed in response to one of:
a human respondent initiating participation in the voice communication, or
a question in the voice communication that requires user participation in the voice communication.

7. The method of claim 6, wherein alerting the user that resumption by the user of user participation in the voice communication is needed further comprises:
providing a notification to one or more connected devices that are connected to the electronic device, wherein the one or more connected devices comprise at least one of a wearable device and an Internet of Things (IoT) device.

8. An electronic device for providing nuance for an artificial intelligence (AI) voice assistant on an electronic device, the electronic device comprising:
at least one processing device on which a voice AI model operates, the at least one processing device configured to:
monitor, using the voice AI model, a first audio segment received for a voice communication by a user to determine a purpose of the voice communication and a current context for the voice communication;
intervene, using the voice AI model, in the voice communication in place of the user by outputting a second audio segment for the voice communication generated by the AI model with a first vocal nuance;
monitor, using the voice AI model, the voice communication subsequent to the second audio segment; and
output, using the voice AI model, a third audio segment for the voice communication generated by the AI model with a second vocal nuance different than the first vocal nuance, the second vocal nuance selected based on information relating to a portion of the voice communication between the second audio segment and the third audio segment.

9. The electronic device of claim 8, wherein the second vocal nuance is selected based on determination by the at least one processing device, from the information relating to the portion of the voice communication between the second audio segment and the third audio segment, of factors including one or more of:
a duration of time between one of the first audio segment and the third audio segment or the second audio segment and the third audio segment;
keywords within the voice communication;
context indicators relating to the voice communication, including indications of progress toward resolution of a subject of the voice communication;
a number of questions occurring during the voice communication; or
a number of changes in a respondent for the voice communication.

10. The electronic device of claim 8, wherein the first vocal nuance and the second vocal nuance are each selected from:
neutral,
assertive, or
satisfied.

11. The electronic device of claim 8, wherein the second audio segment mimics a voice of the user with the first vocal nuance, and wherein the third audio segment mimics the voice of the user with the second vocal nuance.

12. The electronic device of claim 8, wherein the at least one processing device is configured to:
display a graphical user interface (UI) for controlling use of the voice AI model in the voice communication, including
a first user control for initiating intervention using the voice AI model in the voice communication, and
a second user control for initiating resumption by the user of user participation in the voice communication; and
upon resumption by the user of user participation in the voice communication, displaying a summary of the voice communication between the second audio segment and the resumption by the user of user participation in the voice communication.

13. The electronic device of claim 8, wherein the at least one processing device is configured to:
alert the user that resumption by the user of user participation in the voice communication is needed in response to one of:
a human respondent initiating participation in the voice communication, or
a question in the voice communication that requires user participation in the voice communication.

14. The electronic device of claim 13, wherein alerting the user that resumption by the user of user participation in the voice communication is needed further comprises:
providing a notification to one or more connected devices that are connected to the electronic device, wherein the one or more connected devices comprise at least one of a wearable device and an Internet of Things (IoT) device.

15. A non-transitory machine readable medium for providing nuance for an artificial intelligence (AI) voice assistant on an electronic device, the non-transitory machine readable medium comprising instructions that when executed cause at least one processing device of an electronic device to:
monitor, using a voice AI model, a first audio segment received for a voice communication by a user to determine a purpose of the voice communication and a current context for the voice communication;
intervene, using the voice AI model, in the voice communication in place of the user by outputting a second audio segment for the voice communication generated by the AI model with a first vocal nuance;
monitor, using the voice AI model, the voice communication subsequent to the second audio segment; and
output, using the voice AI model, a third audio segment for the voice communication generated by the AI model with a second vocal nuance different than the first vocal nuance, the second vocal nuance selected based on information relating to a portion of the voice communication between the second audio segment and the third audio segment.

16. The non-transitory machine readable medium of claim 15, wherein the second vocal nuance is selected based on determination by the at least one processing device, from the information relating to the portion of the voice communication between the second audio segment and the third audio segment, of factors including one or more of:
a duration of time between one of the first audio segment and the third audio segment or the second audio segment and the third audio segment;
keywords within the voice communication;
context indicators relating to the voice communication, including indications of progress toward resolution of a subject of the voice communication;
a number of questions occurring during the voice communication; or
a number of changes in a respondent for the voice communication.

17. The non-transitory machine readable medium of claim 15, wherein the first vocal nuance and the second vocal nuance are each selected from:
neutral,
assertive, or
satisfied.

18. The non-transitory machine readable medium of claim 15, wherein the second audio segment mimics a voice of the user with the first vocal nuance, and wherein the third audio segment mimics the voice of the user with the second vocal nuance.

19. The non-transitory machine readable medium of claim 15, wherein the instructions when executed cause the at least one processing device to:
display a graphical user interface (UI) for controlling use of the voice AI model in the voice communication, including
a first user control for initiating intervention using the voice AI model in the voice communication, and
a second user control for initiating resumption by the user of user participation in the voice communication; and
upon resumption by the user of user participation in the voice communication, displaying a summary of the voice communication between the second audio segment and the resumption by the user of user participation in the voice communication.

20. The non-transitory machine readable medium of claim 15, wherein the instructions when executed cause the at least one processing device to:
alert the user that resumption by the user of user participation in the voice communication is needed in response to one of:
a human respondent initiating participation in the voice communication, or
a question in the voice communication that requires user participation in the voice communication.
